(19) United States
(12) Patent Application Publication
(10) Pub. No.: US 2026/0099120 A1
(43) Pub. Date: Apr. 9, 2026

(54) CHARGE REMOVAL APPARATUS, IMAGE FORMING SYSTEM, AND DISPLAY METHOD

(71) Applicant: CANON KABUSHIKI KAISHA, Tokyo (JP)

(72) Inventors: HIROKI KOBAYASHI, Ibaraki (JP); AKIHIRO ARAI, Ibaraki (JP)

(21) Appl. No.: 19/276,878

(22) Filed: Jul. 22, 2025

(30) Foreign Application Priority Data
Aug. 5, 2024 (JP) 2024-129221
Aug. 5, 2024 (JP) 2024-129222

(51) Int. Cl. G03G 15/00; G03G 15/16; H04N 1/00

(52) U.S. Cl. CPC G03G 15/6573; G03G 15/1605; G03G 15/5016; G03G 15/55; H04N 1/00015; H04N 1/00034; H04N 1/00037; H04N 1/00074; H04N 1/00082; H04N 1/00909; G03G 2215/00649

(57) ABSTRACT

It is difficult for a user to select an appropriate maintenance method for a non-contact charge removal unit. A charge removal apparatus includes a non-contact charge removal unit including an electrode portion for generating ions and configured to remove charge of a sheet using the ions generated by the electrode portion in a non-contact state with the sheet on which an image is formed by an image forming unit, and a display unit configured to selectively display a cleaning method of the electrode portion from among a plurality of cleaning methods.

### BACKGROUND

### Field of the Technology

The present disclosure relates to a charge removal apparatus, an image forming system, and a display method.

### Description of the Related Art

In an image forming apparatus using an electrophotographic method or an electrostatic recording method, such as a copying machine, a printer, or a facsimile machine, there may be cases where sheets are electrically charged during image formation, the sheets stick together due to an electrostatic force generated between the discharged sheets, and a sheet stacking problem occurs. A charge removal apparatus discussed in Japanese Patent Application Laid-Open No.2019-167169 includes a contact charge removal unit that removes charge in a contact state with a conveyed sheet and includes a non-contact charge removal unit that removes charge in a non-contact state with the sheet.

In a case where the non-contact charge removal unit is continuously used, the charge removal performance of the non-contact charge removal unit may deteriorate due to the deposition of dust in the air or organic materials on an electrode portion of the non-contact charge removal unit.

Thus, it is desirable that the non-contact charge removal unit is cleaned as needed using an appropriate maintenance method depending on the dirtiness degree of the electrode portion. However, it is difficult for a user to determine the dirtiness degree of the electrode portion by visual inspection of the electrode portion of the non-contact charge removal unit, and thus it is difficult for the user to select an appropriate maintenance method from among a plurality of maintenance methods.

### SUMMARY

Some embodiments of the present disclosure are directed to a charge removal apparatus and an image forming system allowing a user to easily select a maintenance method of a non-contact charge removal unit.

According to an aspect of the present disclosure, a charge removal apparatus includes a non-contact charge removal unit including an electrode portion for generating ions and configured to remove charge of a sheet using the ions generated by the electrode portion in a non-contact state with the sheet on which an image is formed by an image forming unit, and a display unit configured to selectively display a cleaning method of the electrode portion from among a plurality of cleaning methods.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system according to a first exemplary embodiment.

FIG. 2 is a schematic diagram illustrating a charge removal apparatus according to a first exemplary embodiment.

FIG. 3 is a control block diagram illustrating configurations of an image forming apparatus and the charge removal apparatus according to the first exemplary embodiment.

FIGS. 4A, 4B, and 4C are diagrams each illustrating a screen display of a user operation unit.

FIG. 5 is a flowchart illustrating a control procedure of an ionizer and the user operation unit according to the first exemplary embodiment.

FIG. 6 is a flowchart illustrating a control procedure of an ionizer and a user operation unit according to a second exemplary embodiment.

FIG. 7 is a flowchart illustrating a control procedure of a main body control unit and the user operation unit according to the second exemplary embodiment.

FIG. 8 is a perspective diagram illustrating a conveyance guide of a non-contact charge removal unit.

FIGS. 9A, 9B, and 9C are diagrams each illustrating a screen display of a user operation unit according to a modification example.

FIG. 10 is a diagram illustrating the image forming system.

FIG. 11 is a perspective diagram illustrating an upper side unit and a lower side unit in a state where the upper side unit is closed.

FIG. 12 is a perspective diagram illustrating the upper side unit and the lower side unit in a state where the upper side unit is open.

FIG. 13 is a flowchart illustrating a control procedure of the ionizer and the user operation unit according to the first exemplary embodiment.

FIGS. 14A, 14B, and 14C are diagrams each illustrating a screen display of a user operation unit according to a modification example.

### DESCRIPTION OF THE EMBODIMENTS

Hereinbelow, with reference to the attached drawings, exemplary embodiments of the present disclosure will be described. Note that dimensions, materials, and relative positional relationships of components of an image forming apparatus and a charge removal apparatus are not intended to limit the range of the present disclosure only thereto unless otherwise specifically described. Further, in the drawings, components that are assigned the same symbols have the same configurations or the same functions, and redundant descriptions thereof are appropriately omitted.

### Schematic Configuration of Image Forming System

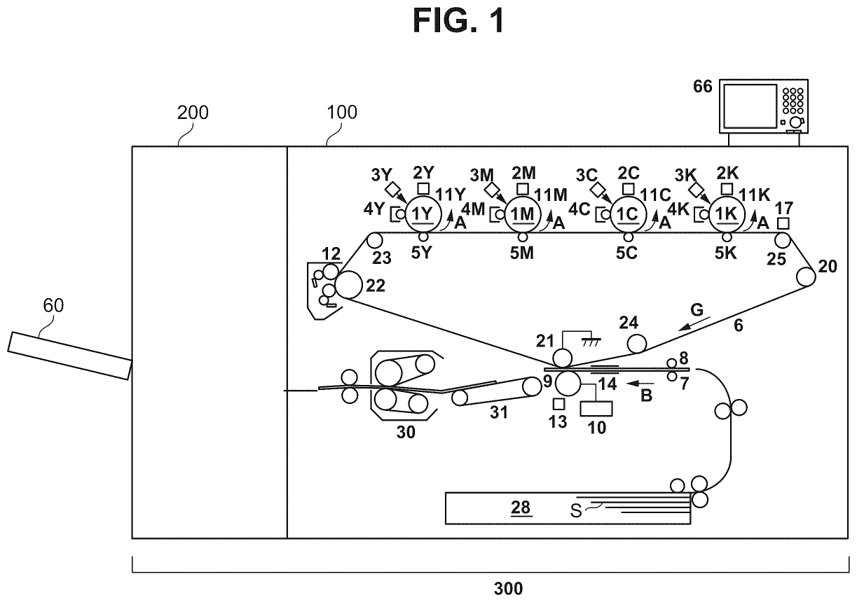

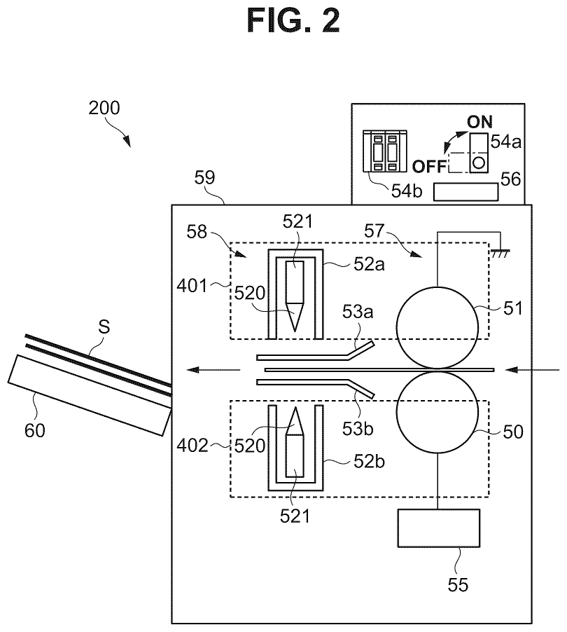

FIG. 1 is a diagram illustrating a configuration of an image forming system 300 according to a first exemplary embodiment. The image forming system 300 includes an image forming apparatus 100 for forming an image on a sheet S and includes a charge removal apparatus 200 for removing charge on the surface of the sheet S. In the schematic diagram of the image forming system 300 in FIG. 1, details of the charge removal apparatus 200 are omitted. A configuration of the charge removal apparatus 200 will be described below with reference to FIG. 2.

First, a schematic configuration of the image forming apparatus 100 will be described. The image forming apparatus 100 forms an image on a sheet using an electrophotographic process. The image forming apparatus 100 includes four image forming units 11Y, 11M, 11C, and 11K respectively for forming yellow (Y), magenta (M), cyan C, and black (K) images, as a plurality of image forming units. These image forming units 11Y, 11M, 11C, and 11K are arranged in line along a moving direction of an image transfer surface of an intermediate transfer belt 6 arranged approximately horizontal with the intermediate transfer belt 6 described below. The image forming units 11 include photosensitive drums 1 (1Y, 1M, 1C, and 1K), charging devices 2 (charging devices 2Y, 2M, 2C, and 2K), exposure devices 3 (3Y, 3M, 3C, and 3K), developing devices 4 (4Y, 4M, 4C, and 4K), and primary transfer rollers 5 (5Y, 5M, 5C, and 5K), respectively.

As illustrated in FIG. 1, each of the photosensitive drums (latent image bearing members) 1Y, 1M, 1C, and 1K rotates in an arrow A direction. The surfaces of the photosensitive drums 1Y, 1M, 1C, and 1K are uniformly charged by the charging device 2Y, 2M, 2C, and 2K, respectively. The exposure devices 3Y, 3M, 3C, and 3K expose the surfaces of the photosensitive drums 1Y, 1M, 1C, and 1K to light based on image information to form electrostatic latent images on the respective surfaces. The developing devices 4Y, 4M, 4C, and 4K contain yellow (Y), magenta (M), cyan C, and black (K) color toners, respectively. The developing devices 4Y, 4M, 4C, and 4K develop the electrostatic latent images with toners to form toner images on the surfaces of the photosensitive drums 1Y, 1M, 1C, and 1K, respectively.

In the present exemplary embodiment, the image forming apparatus 100 employs a reversal developing method of developing the electrostatic latent images by attaching toners on the exposed portions of the electrostatic latent images.

The intermediate transfer belt 6 is arranged so as to contact the surfaces of the photosensitive drums 1Y, 1M, 1C, and 1K. The intermediate transfer belt 6 is stretched around a plurality of stretching rollers 20, 21, 22, 23, 24, and 25 to rotate in an arrow G direction at a rotation speed 150 to 470 mm/sec. In the present exemplary embodiment, the stretching roller 20 is a tension roller for controlling the tensile force of the intermediate transfer belt 6 to be constant. The stretching roller 22 is a drive roller for the intermediate transfer belt 6. The stretching roller 21 is a secondary transfer inside roller. A secondary transfer outside roller 9 nips the sheet S at a secondary transfer nip (secondary transfer portion) formed between the secondary transfer outside roller 9 and the intermediate transfer belt 6 to convey the sheet S.

The primary transfer rollers 5Y, 5M, 5C, and 5K are arranged to face the photosensitive drums 1Y, 1M, 1C, and 1K via the intermediate transfer belt 6 to form primary transfer nips (primary transfer portions) between the primary transfer rollers 5Y, 5M, 5C, and 5K, and the photosensitive drums 1Y, 1M, 1C, and 1K, respectively. In synchronization with the color toner image on the surface of each of the photosensitive drums 1Y, 1M, 1C, and 1K being conveyed to the corresponding primary transfer nip, a transfer bias constant-voltage-controlled to a polarity opposite to that of the toner image is applied to each of the primary transfer rollers 5Y, 5M, 5C, and 5K. In this way, the toner images on the photosensitive drums 1Y, 1M, 1C, and 1K are transferred onto the intermediate transfer belt 6 (primary transfer).

In the vicinity of the intermediate transfer belt 6, an on-belt image reading sensor 17 is disposed. The on-belt image reading sensor 17 reads an image transferred on the intermediate transfer belt 6. The on-belt image reading sensor 17 is, for example, an optical sensor for reading an image by emitting light to the image on the intermediate transfer belt 6, and receiving the reflected light. For example, the on-belt image reading sensor 17 reads an adjustment image for adjusting an image forming condition formed on the intermediate transfer belt 6. A main body central processing unit (CPU) 61 described below analyzes a read result of the adjustment image by the on-belt image reading sensor 17, and feeds back the analyzed result to the image forming condition to perform calibration.

The sheet S stored in a cassette 28 is conveyed to a registration roller 8 by a feed roller and the like, and is temporarily stopped. Then, the registration roller 8 conveys the sheet S to the secondary transfer portion in synchronization with the conveyance of the toner image on the intermediate transfer belt 6 to the secondary transfer nip. A pre-secondary-transfer conveyance guide 14 increases a conveyance accuracy when the sheet S is conveyed to the secondary transfer portion.

A high-voltage application unit 10 applies a transfer bias that is constant-voltage-controlled to a polarity opposite to that of the toner image to the secondary transfer outside roller 9. In this way, the toner image on the intermediate transfer belt 6 is transferred onto the sheet S (secondary transfer). In the present exemplary embodiment, since the toner has a negative (−) polarity, a positive (+) voltage is applied to the secondary transfer outside roller 9. On the other hand, the stretching roller 21 serving as a secondary transfer inside roller is electrically grounded. However, the high-voltage application unit 10 may apply a transfer bias that is constant-voltage controlled to the same polarity as the toner to the stretching roller 21 serving as a secondary transfer inner roller, and the secondary transfer outside roller 9 may be electrically grounded.

A belt member of the pre-fixing conveyance device 31 rotates, and the sheet S with the toner image transferred thereon is placed on and conveyed by the belt member. The fixing device 30 heats and presses the sheet S to fix the toner image onto the sheet S. A belt cleaning device 12 electrostatically collects a secondary transfer residual toner remaining on the intermediate transfer belt 6 without being transferred onto the sheet S, to clean the intermediate transfer belt 6. The cleaned intermediate transfer belt 6 is repeatedly used for the image forming.

A main body display unit 66 is disposed on a housing of the image forming system 300. The main body display unit 66 may be directly fixed to the housing, or connected by a cable with the apparatus and disposed thereon. Further, the main body display unit 66 may wirelessly communicate with the image forming apparatus 100 using Bluetooth® without connecting with the apparatus main body via the cable.

### Schematic Configuration of Charge Removal Apparatus

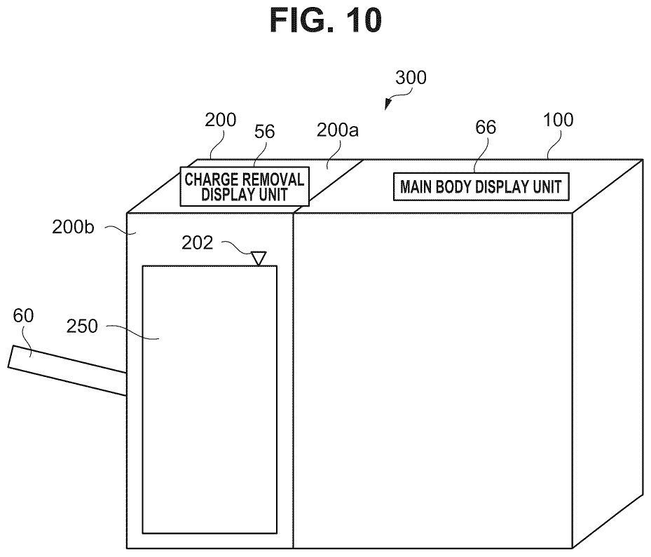

FIG. 2 is a schematic diagram illustrating a configuration of the charge removal apparatus 200. FIG. 10 is a diagram illustrating the image forming system 300. The charge removal apparatus 200 is arranged on the downstream side of the image forming apparatus 100 in a sheet conveyance direction. In the secondary transfer described above, the positive high-voltage is applied to the secondary transfer outside roller 9 (see FIG. 1). Thus, the lower side of the sheet S that has passed through the secondary transfer portion is positively (+) charged, and the upper side of the sheet S is negatively (−) charged due to dielectric polarization. For this reason, when the sheets S are stacked on a sheet discharge tray 60 without being subjected to the charge removal processing, the contact surfaces of the stacked sheets S have polarities different from each other, and there is a concern that the sheets S may stick together due to an electrostatic force.

To prevent the sticking of the sheets S due to the electrostatic force, the charge removal apparatus 200 according to the present exemplary embodiment removes charge on the surfaces (upper surface and lower surface) of the sheet S by a contact charge removal unit 57 and a non-contact charge removal unit 58.

The charge removal apparatus 200 may be directly connected to the image forming apparatus 100, or via a sheet processing apparatus such as an inserter therebetween. In addition, the image forming apparatus 100 and the charge removal apparatus 200 may be integrally configured as the image forming apparatus 100. In addition, the image forming apparatus 100 and the charge removal apparatus 200 may be integrally configured as the charge removal apparatus 200. In other words, the housing of the image forming apparatus 100 and the housing of the charge removal apparatus 200 may be integrally configured or may be divided into a plurality of housings.

The charge removal apparatus 200 includes a housing 59, a contact charge removal unit 57, a non-contact charge removal unit 58, a conveyance guide 53 including an upper side conveyance guide 53a and a lower side conveyance guide 53b, and a control unit (not illustrated) for performing overall control of the charge removal apparatus 200. Further, the charge removal apparatus 200 includes a charge removal operation unit 54 including a mode lever 54a and a dial 54b, and a charge removal display unit 56. The electrification charge of the sheet S conveyed from the image forming apparatus 100 is roughly removed by the contact charge removal unit 57 for removing charge in a state contacting the sheet. Next, the charge of the sheet S that has not been removed by the contact charge removal unit 57 is removed by the non-contact charge removal unit 58 for removing charge of the sheet S in a state not contacting the sheet S, and then the sheet S is discharged outside the charge removal apparatus 200. Details of the contact charge removal unit 57, the non-contact charge removal unit 58, and the charge removal operation unit 54 will be below.

The charge removal display unit 56 includes light-emitting diodes (LEDs), and disposed on a top surface 200a (apparatus upper surface) of an exterior that covers the housing 59, as illustrated in FIG. 10. In addition, the charge removal display unit 56 may be disposed on a front surface 200b (apparatus front surface) of the exterior of the charge removal apparatus 200. The surface facing the apparatus front side of the charge removal apparatus 200 is the front surface 200b, and includes an inclined surface inclining so as to intersect with the vertical direction. Since the charge removal display unit 56 is disposed on the top surface 200a or the front surface 200b in the exterior of the charge removal apparatus 200, a user can check the displayed content when the user uses the charge removal apparatus 200. In other words, the charge removal display unit 56 merely needs to be disposed outside the exterior. For example, the charge removal display unit 56 may be directly fixed to the exterior, or connected via a cable with the apparatus main body of the charge removal apparatus 200 and disposed thereon. Further, the charge removal display unit 56 may wirelessly communicate with the apparatus main body using Bluetooth® without connecting therewith via the cable. The charge removal display unit 56 turns ON/OFF depending on a state of an ionizer 52 consisting including ionizers 52a and 52b of the non-contact charge removal unit 58.

In the present exemplary embodiment, the charge removal display unit 56 includes LEDs, but it is not limited thereto, and may be a display such as a liquid crystal display (LCD). Further, the charge removal display unit 56 may display information about the contact charge removal unit 57, not limited to the information about the non-contact charge removal unit 58.

A door 250 (see FIG. 10) configuring the apparatus front surface is provided on the charge removal apparatus 200, and the door 250 is configured to be openable/closable relative to the housing 59 by an open/close mechanism (not illustrated). The open/close of the door 250 of the charge removal apparatus 200 is detected by a door sensor 202. A user can access an upper side unit 401 and a lower side unit 402, by opening the door 250. More specifically, as illustrated in FIG. 2, the charge removal opposing roller 51 and the ionizer 52a are arranged in the upper side unit 401, and the charge removal roller 50, the ionizer 52b, and the conveyance guide 53 are arranged in the lower side unit 402. In addition, the upper side unit 401 is configured to be openable/closable relative to the lower side unit 402.

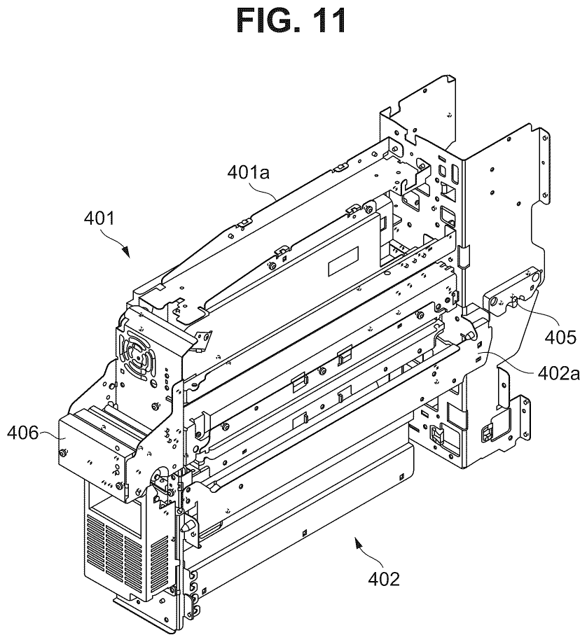

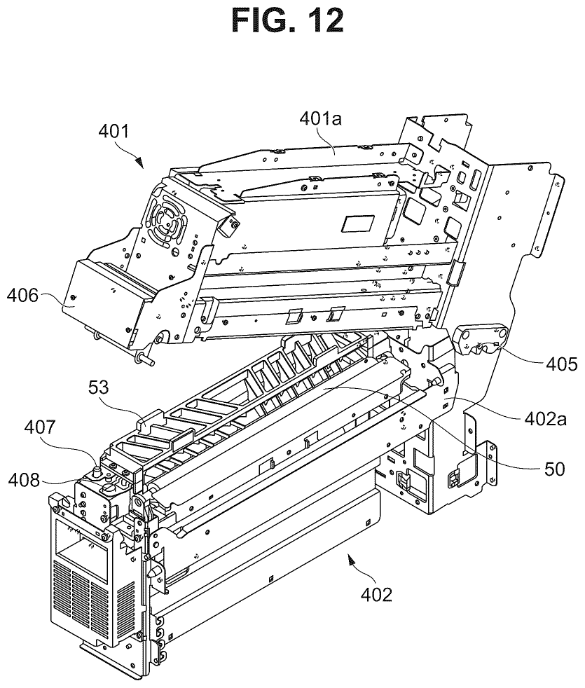

FIG. 11 is a perspective diagram illustrating the upper side unit 401 and the lower side unit 402 in a state where the upper side unit 401 is closed. FIG. 12 is a perspective diagram illustrating the upper side unit 401 and the lower side unit 402 in a state where the upper side unit 401 is open. The upper side unit 401 includes an upper side chassis 401a made of a sheet metal or the like, and the ionizer 52a is fixed to the upper side chassis 401a. The lower side unit 402 includes a lower side chassis 402a made of a sheet metal or the like, and the ionizer 52b is fixed to the lower side chassis 402a. Further, the lower side unit 402 is fixed to the housing 59 of the charge removal apparatus 200 so as not to move. On the other hand, the upper side unit 401 is configured to be rotatable relative to the lower side unit 402 around a rotation shaft 405. The upper side unit 401 is provided with a handle 406. In addition, since the upper side unit 401 rotates inside the housing 59, the rotatable range of the upper side unit 401 is restricted by the height of the top surface of the housing 59. In other words, the upper side unit 401 is rotatable within the range from the closed state to the state where the upper side unit 401 is brought into contact with the top surface of the housing 59.

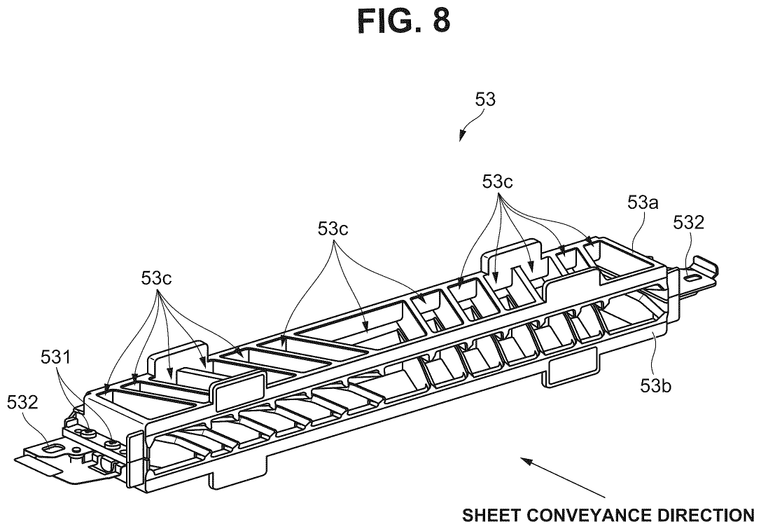

The conveyance guide 53 is provided with two fitting holes 532 (see FIG. 8), into which protrusions 407 described below fit, on both sides of the conveyance path in a width direction orthogonal to the sheet conveyance direction. On the other hand, as illustrated in FIG. 12, the lower side unit 402 is provided with the two protrusions 407 protruding upward on both sides of the conveyance path in the width direction orthogonal to the sheet conveyance direction. The two fitting holes 532 of the conveyance guide 53 are respectively fitted into the protrusions 407 of the lower side unit 402 to position the conveyance guide 53 with respect to the lower side unit 402. The positioned conveyance guide 53 is attached to the lower side chassis 402a of the lower side unit 402 with a screw 408 serving as a fixing member arranged on the apparatus front side in an attachable/detachable manner. However, the conveyance guide 53 may be configured to be rotatable relative to the lower side unit 402, and fixed to the lower side unit 402 with an engaging member, not limited to the screw.

In the configuration described above, in a case where a user cleans a charge removal needle 520 of the ionizer 52a, first, the user opens the door 250, and grips the handle 406 to rotate the upper side unit 401 upward. In this way, the user can access the charge removal needle 520 of the ionizer 52a. Further, in a case where the user cleans a charge removal needle 520 of the ionizer 52b, the user detaches the conveyance guide 53 from the lower side unit 402 after rotating the upper side unit 401 upward. In this way, the user can access the charge removal needle 520 of the ionizer 52b, and the user can clean (maintain) the ionizer 52 of the non-contact charge removal unit 58.

### Contact Charge Removal Unit

The contact charge removal unit 57 includes the charge removal roller 50 serving as a contact charge removal unit, the charge removal opposing roller 51, and a high-voltage substrate 55 for generating a high voltage to be applied to the charge removal roller 50. The charge removal roller 50 consists of an elastic layer made of an ion conductive foamed rubber and a core metal. The charge removal roller 50 has an external diameter of 20 to 25 mm, the resistance value of the charge removal roller 50 is 1×10⁵ to 1×10⁸Ω measured by applying a voltage of 2 kV in the environment of 23° C. and 50% RH, and the charge removal roller 50 is a member similar to that of the secondary transfer outside roller 9. A charge removal voltage, which is a constant-voltage-controlled direct current voltage, is applied to the charge removal roller 50 from the high-voltage substrate 55. In the present exemplary embodiment, as described above, the sheet S is conveyed to the charge removal apparatus 200 in the state where the upper side of the sheet S is negatively charged, and the lower side of the sheet S is positively charged. Thus, the high-voltage substrate 55 applies a negative voltage to the charge removal roller 50 disposed on the lower side of the sheet S.

The charge removal opposing roller 51 is made of stainless steel (SUS), and is electrically grounded (connected to the ground). The charge removal opposing roller 51 is a roller with an external diameter of 20 to 25 mm, and disposed at a position facing the charge removal roller 50.

The charge removal roller 50 and the charge removal opposing roller 51 form a charge removal nip portion. The charge removal roller pair consisting of the charge removal roller 50 and the charge removal opposing roller 51 roughly removes the electrification charge of the sheet S in a state contacting the sheet S. The contact charge removal unit 57 according to the present exemplary embodiment is high in charge removal efficiency because the contact charge removal unit 57 directly contacts the sheet S and directly applies the voltage. On the other hand, the contact charge removal unit 57 has a property that a large variation of the surface potential of the sheet S is caused after the charge removal, and the charge removal tends to become uneven. In response, the charge removal apparatus 200 according to the present exemplary embodiment is provided with the non-contact charge removal unit 58 on the downstream side of the contact charge removal unit 57 in the sheet conveyance direction.

In the present exemplary embodiment, the charge removal opposing roller 51 rotates by receiving a drive force from a charge removal drive motor (not illustrated) to convey the sheet S nipped by the charge removal nip. In the present exemplary embodiment, the negative voltage is applied to the charge removal roller 50 from the high-voltage substrate 55, and the charge removal opposing roller 51 is electrically grounded, but it is not limited thereto. A positive voltage may be applied to the charge removal opposing roller 51 from the high-voltage substrate 55, and the charge removal roller 50 may be electrically grounded.

### Non-contact Charge Removal Unit

The non-contact charge removal unit 58 is configured of the ionizer 52 including the ionizer 52a and the ionizer 52b serving as a non-contact charge removal unit. A bar type ionizer extending in a width direction orthogonal to the sheet conveyance direction is used for each of the ionizers 52a and 52b according to the present exemplary embodiment, and each of the ionizers 52a and 52b includes the charge removal needle 520 to generate ions and an ionizer control unit 521 for controlling the ionizer 52. The ionizers 52a and 52b are respectively arranged above and below the conveyance guide 53. More specifically, the ionizer 52a is arranged above the conveyance guide 53, and the ionizer 52b is arranged below the conveyance guide 53. An alternate-current (AC) bias is applied to the ionizer 52, positive and negative ions are released alternately due to the corona discharge. Thus, it is possible to remove the charge on the front and back sides of the sheet S, regardless of the polarity of the remaining charge on the sheet S in the contact charge removal unit 57. The discharge effect on the sheet S by the non-contact charge removal unit 58 according to the present exemplary embodiment is smaller than that by the contact charge removal unit 57, but the unevenness of the surface potential of the sheet S after the charge removal processing is smaller. For this reason, the non-contact charge removal unit 58 can smooth the surface potential of the sheet S that has become uneven by the contact charge removal unit 57. The charge removal needle 520 according to the present exemplary embodiment is an example of the electrode portion.

The conveyance guide 53 is a member for guiding the sheet S, and configured of the upper side conveyance guide 53a disposed facing the upper side of the sheet S and the lower side conveyance guide 53b disposed facing the lower side of the sheet S. The conveyance guide 53 is disposed below the ionizer 52a in the vertical direction arranged in the upper side unit 401, and above the ionizer 52b arranged in the lower side unit 402 in the vertical direction. In other words, the conveyance guide 53 is disposed between the ionizer 52a and the ionizer 52b in the vertical direction. The sheet S that has passed through the charge removal roller pair consisting of the charge removal roller 50 and the charge removal opposing roller 51 is conveyed between the upper side conveyance guide 53a and the lower side conveyance guide 53b. The upper side conveyance guide 53a and the lower side conveyance guide 53b are made of an insulative resin made by combining polycarbonate (PC) and acrylonitrile-butadiene-styrene (ABS). In the present exemplary embodiment, the volume resistivity of the conveyance guide 53 according to the present exemplary embodiment is 1×10¹⁴ Ω·cm.

FIG. 8 is a perspective diagram illustrating the conveyance guide 53. The upper side conveyance guide 53a is provided with openings 53c so that the ions emitted from the charge removal needle 520 serving as an ion emission unit are not physically blocked by the conveyance guide 53. More specifically, the upper side conveyance guide 53a is provided with a plurality of the openings 53c arranged in a width direction orthogonal to the sheet conveyance direction. Similarly, the lower side conveyance guide 53b is provided with a plurality of the openings. The upper side conveyance guide 53a and the lower side conveyance guide 53b configure a guide unit (conveyance guide 53) by fixing them with a plurality of screws 531 provided on both sides in the width direction.

In addition, in the present exemplary embodiment, the ionizer 52 is employed as the non-contact charge removal unit, but it is not limited thereto. For example, as the non-contact charge removal unit, an AC corotron method of applying a high voltage to a wire may be used. Further, in the present exemplary embodiment, the ionizers 52a and 52b are disposed above and below the sheet S, but it is not limited thereto. For example, the ionizer 52 may be disposed only above the sheet S or below the sheet S. Further, the high voltage to be applied may be a direct-current (DC) voltage not the AC voltage.

### Configuration of Charge Removal Operation Unit

In the present exemplary embodiment, the charge removal apparatus 200 includes two charge removal units of the contact charge removal unit 57 and the non-contact charge removal unit 58, to remove charge of the sheet S using the two charge removal units. However, the charge removal apparatus 200 can remove the charge of the sheet S by operating only the non-contact charge removal unit 58 without operating the contact charge removal unit 57. For example, it is possible to sufficiently remove the charge of a sheet with a low electric resistance such as plain paper by using only the non-contact charge removal unit 58 without using the contact charge removal unit 57.

On the other hand, it is preferable to remove the charge of a sheet with a high electric resistance such as synthetic paper using both the contact charge removal unit 57 and the non-contact charge removal unit 58. Thus, a user can arbitrarily change the setting of the charge removal apparatus 200 using the charge removal operation unit 54 depending on a type of the sheet to be printed in a job.

The charge removal operation unit 54 is disposed on the top surface 200a (apparatus upper surface) of the housing of the charge removal apparatus 200. However, the charge removal operation unit 54 may be disposed on the front surface 200b (apparatus front surface) of the housing of the charge removal apparatus 200. In the present exemplary embodiment, the charge removal operation unit 54 includes the mode lever 54a and the dial 54b. The mode lever 54a is a selector switch for manually switching ON/OFF (enabled/disabled) of the voltage application to the charge removal roller 50 from the high-voltage substrate 55. In addition, even when the mode lever 54a is in the OFF state, the sheet S is conveyed. In addition, even when the mode lever 54a is in the OFF state, the non-contact charge removal unit 58 performs the charge removal.

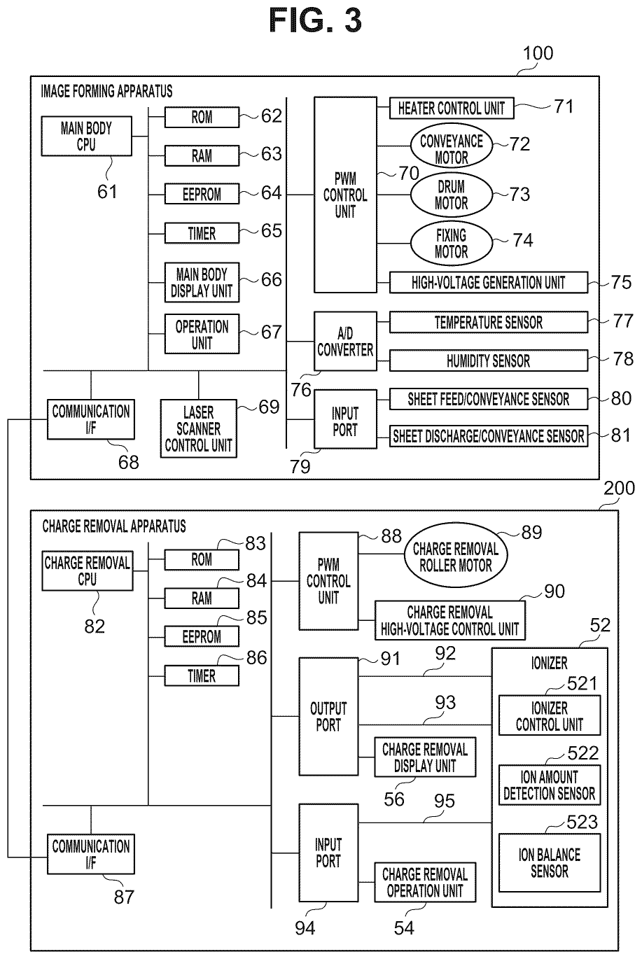

The dial 54b is a thumb rotary switch for manually setting a voltage value to be applied to the charge removal roller 50 from the high-voltage substrate 55. In the present exemplary embodiment, since the charge removal operation unit 54 includes two manual setting units of the mode lever 54a and the dial 54b, the user can change the setting of the mode lever 54a without changing the setting of the dial 54b. However, the voltage value to be applied to the charge removal roller 50 is not limited to the manual setting by the user. The image forming apparatus 100 may transmit the type of the sheet to the charge removal apparatus 200, and a charge removal CPU 82 (see FIG. 3) of the charge removal apparatus 200 may determine the voltage value to be applied to the charge removal roller 50 based on the type of the sheet. Further, the charge removal apparatus 200 may be provided with a detection roller or a surface potential sensor for detecting the charge amount of the sheet, to measure the charge amount of the sheet after the image forming, and the charge removal CPU 82 may determine the voltage value to be applied to the charge removal roller 50 based on the measured charge amount of the sheet.

### Image Forming System Block Diagram

FIG. 3 is a block diagram illustrating electrical configurations of the image forming apparatus 100 and the charge removal apparatus 200. First, the configuration of the image forming apparatus 100 will be described. The image forming apparatus 100 includes the main body CPU 61, a read only memory (ROM) 62, a random access memory (RAM) 63, an electrically erasable programmable read only memory (EEPROM) 64, a timer 65, the main body display unit 66, an operation unit 67, a communication interface (I/F) 68, a laser scanner control unit 69, a pulse width modulation (PWM) control unit 70, an analog-to-digital (A/D) converter 76, and an input port 79. These components are connected via a system bus. Further, a heater control unit 71, a conveyance motor 72, a drum motor 73, a fixing motor 74, and a high-voltage generation unit 75 are connected to the PWM control unit 70. A temperature sensor 77 and a humidity sensor 78 are connected to the A/D converter 76. A sheet feed/conveyance sensor 80 and a sheet discharge/conveyance sensor 81 are connected to the input port 79.

The main body CPU 61 integrally performs image processing control and printing control based on a stored program and the like.

The ROM 62 and the EEPROM 64 store programs and data required when the main body CPU 61 performs various kinds of processing, and the RAM 63 functions as a work area. The timer 65 is used when the main body CPU 61 performs various timing controls. The main body display unit 66 displays setting information of the image forming apparatus 100 and a print job processing status. The operation unit 67 receives various setting inputs and operation instructions from a user. The communication I/F 68 is connected to the charge removal apparatus 200 via a communication cable, and performs communications to control each apparatus.

The laser scanner control unit 69 is a device for emitting a laser beam modulated based on image data to each of the photosensitive drums 1 (1Y to 1K) each charged to form an electrostatic latent image. The laser scanner control unit 69 irradiates each of the photosensitive drums 1 which are evenly negatively charged by the high-voltage generation unit 75 described below, with a laser beam deflected by a polygon mirror. In this way, the negative charges at positions on each of the photosensitive drums 1 irradiated with the laser beam are neutralized, and an electrostatic latent image is formed.

The PWM control unit 70 controls the heater control unit 71, the conveyance motor 72, the drum motor 73, the fixing motor 74, and the high-voltage generation unit 75. The heater control unit 71 controls the temperature of the fixing device 30. The conveyance motor 72 drives a conveyance roller for conveying a sheet, and the pre-fixing conveyance device 31. The drum motor 73 rotationally drives the photosensitive drums 1. The fixing motor 74 drives a fixing belt and the like of the fixing device 30. The A/D converter 76 performs A/D conversion of converting analog signals output from the temperature sensor 77 and the humidity sensor 78 into digital signals. The input port 79 receives signals output from the sheet feed/conveyance sensor 80 and the sheet discharge/conveyance sensor 81.

Next, the configuration of the charge removal apparatus 200 will be described. The charge removal apparatus 200 includes the charge removal CPU 82, a ROM 83, a RAM 84, an EEPROM 85, a timer 86, a communication I/F 87, a PWM control unit 88, an output port 91, and an input port 94. These components are connected via a system bus. Further, a charge removal roller motor 89 and a charge removal high-voltage control unit 90 are connected to the PWM control unit 88. An ionizer ON/OFF signal 92 and a maintenance detection mode shift signal 93 are output from the output port 91. Further, the charge removal display unit 56 is connected to the output port 91, and data corresponding to information to be displayed on the charge removal display unit 56 is output from the output port 91. A maintenance detection signal 95 is input and the charge removal operation unit 54 is connected to the input port 94. The ionizer ON/OFF signal 92 and the maintenance detection mode shift signal 93 are input to the ionizer 52, and the maintenance detection signal 95 is output from the ionizer 52.

The charge removal CPU 82 performs various kinds of controls required for removing the charge from the sheet S and discharging the sheet S, based on the stored program and the like. The ROM 83 and the EEPROM 85 store programs and data required when the charge removal CPU 82 performs various kinds of processing. The RAM 84 functions as a work area. The timer 86 is used by the charge removal CPU 82 for controlling various kinds of timings, and measuring the operation time period of the ionizer 52. The communication I/F 87 is connected to the image forming apparatus 100 via a communication cable, and performs communications to control each apparatus.

The PWM control unit 88 controls the charge removal roller motor 89 and the charge removal high-voltage control unit 90 to remove charge from the sheet discharged from the image forming apparatus 100, and convey the sheet. The output port 91 outputs the ionizer ON/OFF signal 92, the maintenance detection mode shift signal 93, and ON/OFF of the charge removal display unit 56. The input port 94 receives the maintenance detection signal 95 and ON/OFF of the charge removal operation unit 54.

The ionizer 52 switches between generating and stopping the ions based on the ionizer ON/OFF signal 92. When the ionizer ON/OFF signal 92 is a high (H) level, the ionizer 52 becomes an ion generation state, and when the ionizer ON/OFF signal 92 is a low (L) level, the ionizer 52 becomes an ion stop state. The charge removal CPU 82 controls the ion generation and stop by switching the ionizer ON/OFF signal 92 at a predetermined timing.

The maintenance detection mode shift signal 93 is a signal that shifts the ionizer 52 to the maintenance detection mode for determining whether a maintenance of the electrode portion is required. The maintenance detection signal 95 is a signal output in a case where the maintenance of the electrode portion is required in the maintenance detection mode of the ionizer 52. More specifically, the ionizer control unit 521 shifts to the maintenance detection mode for determining whether the maintenance is required in response to the switching of the maintenance detection mode shift signal 93 from the L level to the H level as a trigger. The ionizer control unit 521 determines whether the maintenance is required during the maintenance detection mode. In addition, in the maintenance detection mode, the ionizer control unit 521 continues the maintenance detection until the H level of the maintenance detection signal 95 is output or a predetermined time period elapses. The necessity of maintenance is reflected on the maintenance detection signal 95. More specifically, in a case where the predetermined time has elapsed while the maintenance detection signal 95 is kept to be the L level, it indicates that the maintenance is not required, and in a case of the H level, it indicates that the maintenance is required. In addition, the maintenance detection mode shift signal 93 is switched from the H level to the L level after 100 ms elapses since the switching from the L level to the H level.

In a case where the ionizer control unit 521 detects the H level of the maintenance detection signal 95, the charge removal CPU 82 determines the dirtiness degree of the ionizer 52 based on the time at which the ionizer control unit 521 receives the maintenance detection signal 95, and displays a suitable maintenance method based on the dirtiness degree on the main body display unit 66 via the communication I/F 87. Further, the main body display unit 66 displays, in addition to the suitable maintenance method, a maintenance warning for recommending that a user is to perform the maintenance. In addition, in the following descriptions, the state where the maintenance detection signal 95 is at the H level corresponds to the state where the maintenance detection signal 95 is output.

The charge removal CPU 82 switches the maintenance detection mode shift signal 93 from the L level to the H level at a predetermined timing to shift the ionizer 52 to the maintenance detection mode. In the present exemplary embodiment, whether to execute the maintenance detection control is determined based on the driving time period of the ionizer 52, but it is not limited thereto. For example, it may be determined based on the number of printed sheets.

### Maintenance Detection Control of Ionizer

In the present exemplary embodiment, the ionizer control unit 521 performs the maintenance detection control. The ionizer 52 includes an ion amount detection sensor 522 for detecting an ion amount, and an ion balance sensor 523 for detecting the balance of positive ions and negative ions. In a case where the ionizer 52 detects the maintenance detection mode shift signal 93, the ionizer 52 starts operating, and the ion amount detection sensor 522 detects an ion generation amount per unit time. In a case where a prescribed voltage value is applied to the charge removal needle 520 and the detected ion generation amount is less than a predetermined amount, the ionizer control unit 521 outputs the maintenance detection signal 95.

In a case where the detected ion generation amount is the predetermined amount or more, the positive voltage or the negative voltage applied to the charge removal needle 520 is gradually increased so as to make the ion balance detected by the ion balance sensor 523 within a predetermined range. In addition, in the present exemplary embodiment, a positive voltage (positive high-voltage pulse) and a negative voltage (negative high-voltage pulse) are alternately and repeatedly applied to the charge removal needle 520. More specifically, a feedback control for adjusting the ion balance between the positive ions and negative ions is performed by increasing the amplitude of the positive or negative voltage. In other words, the positive or negative voltage is controlled so as to make the ion balance detected by the ion balance sensor 523 approach 0. At this time, “ion balance within the predetermined range” means that the difference between the amount of the positive ions and the amount of negative ions generated from the ionizer 52 (ionizer 52a or 52b) in one of the upper side unit 401 and the lower side unit 402 is within a predetermined range. In a case where the ion balance does not fall in the predetermined range even though the ionizer 52 increases the voltage to be applied to the charge removal needle 520 to the prescribed upper limit, the ionizer control unit 521 outputs the maintenance detection signal 95. On the other hand, even in a case where the ion balance falls in the predetermined range, the ionizer control unit 521 continues the maintenance detection control for 30 seconds after the detection of the maintenance detection mode shift signal 93. The maintenance detection control ends 30 seconds after the detection of the maintenance detection mode shift signal 93.

In other words, the ionizer control unit 521 outputs the maintenance detection signal 95, in the case where the ion generation amount of the ionizer 52 is less than the predetermined ion amount, and the ion balance is not within the predetermined range. In the present exemplary embodiment, the ionizer 52 includes the ion amount detection sensor 522 and the ion balance sensor 523, but it is not limited thereto. The ionizer control unit 521 may calculate the ion generation amount or the ion balance based on positive and negative ion currents (return currents) returning to an ionizer circuit via the ground.

Output timings of the maintenance detection signal 95 are different between a case where the ion generation amount is less than the predetermined amount and a case where the ion generation amount is the predetermined amount or more and the voltage applied to the charge removal needle 520 in the ion balance adjustment reaches the upper limit. More specifically, in the case where the ion generation amount is less than the predetermined amount, the timing at which the maintenance detection signal 95 is output is earlier than that in the case where the ion generation amount is the predetermined amount or more and the voltage applied to the charge removal needle 520 in the ion balance adjustment reaches the upper limit. Thus, the charge removal CPU 82 determines the dirtiness degree of the ionizer 52 based on the timing at which the maintenance detection signal 95 is detected via the input port 94.

In the present exemplary embodiment, the charge removal CPU 82 determines that the dirtiness degree of the ionizer 52 is heavy, in a case where the timing at which the maintenance detection signal 95 is detected is within a predetermined time period serving as a threshold value after the maintenance detection mode shift signal 93 is output. Further, the charge removal CPU 82 determines that the dirtiness degree of the ionizer 52 is light, in a case where the maintenance detection signal 95 is detected later than the predetermined time after the maintenance detection mode shift signal 93 is output.

In other words, in the case where the ion generation amount is less than the predetermined amount, the charge removal CPU 82 determines that the dirtiness degree of the charge removal needle 520 is heavy, and in the case where the ion generation amount is the predetermined amount or more and the ion balance is unbalanced, the charge removal CPU 82 determines that the dirtiness degree of the charge removal needle 520 is light. The charge removal CPU 82 notifies the image forming apparatus 100 of the information of the determined dirtiness degree.

In the present exemplary embodiment, the dirtiness degree of the ionizer 52 is determined in two levels, but the threshold values may be set smaller to increase the number of determination levels. However, in the present exemplary embodiment, the dirtiness degree is a level of the dirtiness in the case where the cleaning of the ionizer is required, and whether the cleaning is required does not indicate the dirtiness degree of the ionizer 52. Thus, the dirtiness degree of the ionizer 52 at which the cleaning is required in the present exemplary embodiment has at least two levels.

In the maintenance detection control according the present exemplary embodiment, the determination is performed based on the ion generation amount and the ion balance, but another method may be used. For example, the determination may be performed by using only the ion generation amount. In this case, the charge removal display unit 56 may display the dirtiness degree as a parameter using the ion generation amount or the like. For example, the ratio of the value of the ion generation amount measured in the maintenance detection to the value of the ion generation amount of the ionizer 52 in a reference state may be calculated and displayed. In this case, the lower the calculated value is, the dirtier the ionizer 52 is. Further, based on the calculated value, the dirtiness degree of the ionizer 52 may be visualized as an object other than a numeric value.

Further, in the present exemplary embodiment, the dirtiness degree is determined by setting the threshold value for the time period until the maintenance detection signal 95 from the ionizer 52 is detected, but the dirtiness degree may be determined by dividing the signal output from the ionizer 52 into a plurality of signals and changing the output destinations thereof.

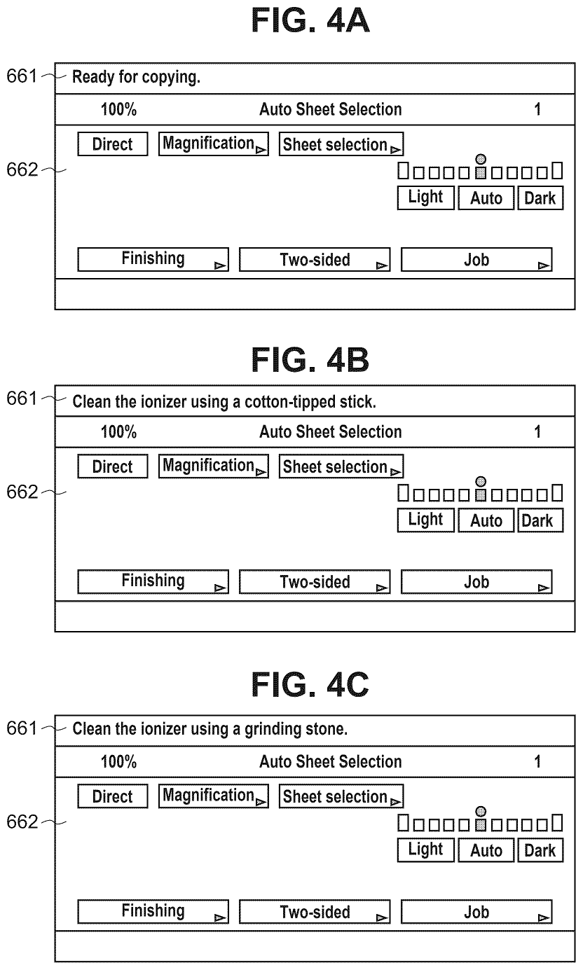

FIGS. 4A, 4B, and 4C are diagrams illustrating screen display examples displayed on the main body display unit 66. In order to keep the charge removal ability of the ionizer 52, a user needs to perform a maintenance of the electrode portion appropriately. For example, if the cleaning is performed at every maintenance timing using a grinding stone, it is an excessive maintenance, and there is a possibility of accelerating the deterioration of the electrode portion. On the other hand, if the cleaning is performed at every maintenance timing using a cotton-tipped stick, the dirtiness cannot be sufficiently removed, and there is a possibility of deteriorating the charge removal ability. Thus, it is desirable for a user to grasp the dirtiness degree of the electrode portion, and perform the maintenance by an appropriate method.

In the present exemplary embodiment, a user can check the maintenance method of the ionizer 52 on the main body display unit 66. The main body display unit 66 includes a status area 661 for displaying a dirtiness degree of the ionizer 52 or a maintenance method, and a job setting area 662 for setting job contents. FIG. 4A illustrates a display screen of the main body display unit 66 displayed in a case where the maintenance detection signal 95 is not output. FIG. 4B illustrates a display screen of the main body display unit 66 displayed in a case where the dirtiness degree is determined to be light. FIG. 4C is a display screen of the main body display unit 66 displayed in a case where the dirtiness degree is determined to be heavy. More specifically, the screen in FIG. 4A does not display a message for prompting the user to clean the ionizer 52. The screen in FIG. 4B displays a message for prompting the user to clean the ionizer 52 using a cotton-tipped stick. The screen in FIG. 4C displays a message for prompting the user to clean the ionizer 52 using a grinding stone. In other words, the main body display unit 66 selectively displays a cleaning method of the ionizer 52 from among the plurality of cleaning methods.

In a case where the ionizer 52 outputs the maintenance detection signal 95, the charge removal CPU 82 determines the dirtiness degree of the ionizer 52 based on the reception timing of the maintenance detection signal 95. The charge removal CPU 82 transmits a notification of the determined dirtiness degree of the ionizer 52, or information about the cleaning method corresponding to the determined dirtiness degree to the main body CPU 61 via the communication I/F 87. The main body CPU 61 displays an appropriate cleaning method on the main body display unit 66 based on the transmitted information. In other words, the charge removal CPU 82 determines the cleaning method based on the reception timing of the maintenance detection signal 95.

In a case where the charge removal CPU 82 determines that the dirtiness degree of the ionizer 52 is light (first dirtiness degree), the main body CPU 61 displays the screen of the main body display unit 66 in FIG. 4B to recommend the maintenance using a cotton-tipped stick (first cleaning method). In a case where the charge removal CPU 82 determines that the dirtiness degree of the ionizer 52 is heavy (second dirtiness degree), the main body CPU 61 displays the screen of the main body display unit 66 in FIG. 4C to recommend the maintenance using a grinding stone (second cleaning method). In other words, the charge removal CPU 82 determines the dirtiness degree of the ionizer 52 or the maintenance method therefor based on the reception timing of the maintenance detection signal 95, and the main body CPU 61 causes the main body display unit 66 to display the maintenance method corresponding to the determination result on the screen. In addition, in a case where the charge removal CPU 82 determines that the cleaning of the ionizer 52 is not required, the main body CPU 61 causes the main body display unit 66 to display the screen in FIG. 4A. In other words, in the case where the cleaning of the ionizer 52 is not required, the charge removal CPU 82 does not display the message to prompt the user to clean the ionizer 52. In the present exemplary embodiment, the cotton-tipped stick is an example of a first member serving as a soft material, and the grinding stone is an example of a second member harder than the first member.

### Description of Flowchart

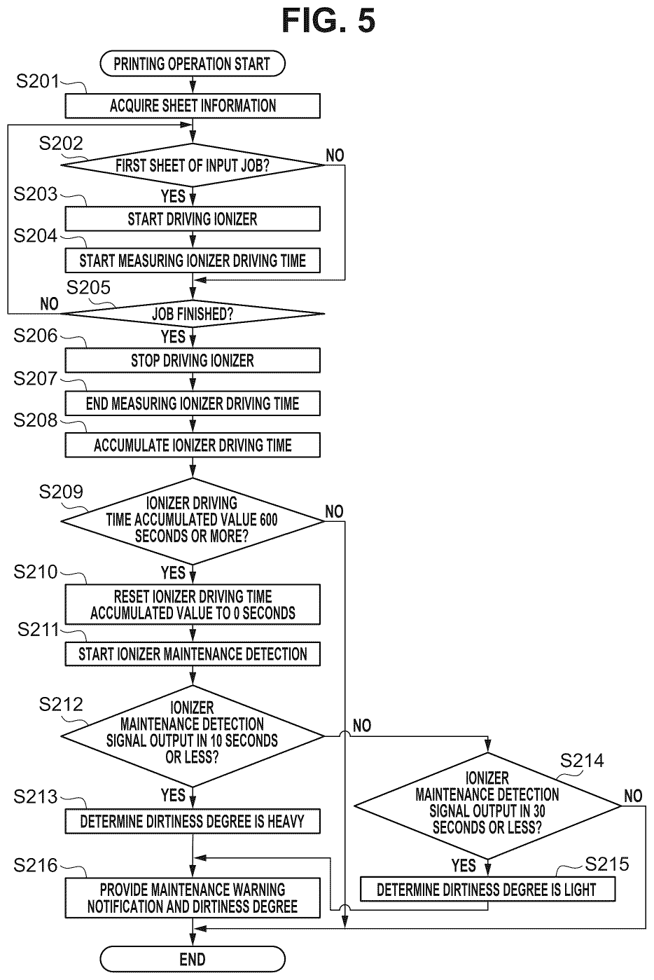

FIG. 5 is a flowchart illustrating a control flow performed by the charge removal CPU 82.

In step S201, when a print job is input, the charge removal CPU 82 acquires sheet information via the communication I/F 87. In step S202, the charge removal CPU 82 determines whether it is a first sheet of the input job. In a case where it is the first sheet of the input job (YES in step S202), the charge removal CPU 82 switches the ionizer ON/OFF signal 92 from the L level to the H level, and the processing proceeds to step S203. In step S203, the charge removal CPU 82 starts driving the ionizer 52. Then, in step S204, the timer 86 starts measuring the driving time period of the ionizer 52. In a case where it is not the first sheet of the job (NO in step S202), the processing proceeds to step S205. In step S205, when the sheet S with an image formed thereon passes through the ionizer 52, the charge removal CPU 82 determines whether the print job has been finished. More specifically, the charge removal CPU 82 determines whether the last sheet of the print job has passed therethrough. In a case where the last sheet of the print job has not passed therethrough (NO in step S205), the charge removal CPU 82 repeats the processing from steps S202 to S205. In a case where the last sheet has passed therethrough (YES in step S205), the charge removal CPU 82 switches the ionizer ON/OFF signal 92 from the H level to the L level, and the processing proceeds to step S206. In step S206, the charge removal CPU 82 stops driving the ionizer 52. In step S207, the charge removal CPU 82 ends measuring the driving time of the ionizer 52.

Next, in step S208, the charge removal CPU 82 accumulates the driving time of the ionizer 52 measured by the timer 65. In step S209, the charge removal CPU 82 determines whether the driving time accumulated value is 600 seconds or more. In a case where the driving time accumulated value is 600 seconds or more (YES in step S209), the processing proceeds to step S210. In step S210, the charge removal CPU 82 resets the driving time accumulated value of the ionizer 52 to 0. In step S211, the charge removal CPU 82 switches the maintenance detection mode shift signal 93 from the L level to the H level to cause the ionizer 52 to start the maintenance detection.

In step S212, the charge removal CPU 82 determines whether the ionizer 52 outputs the maintenance detection signal 95 in 10 seconds or less. In a case where the ionizer 52 outputs the maintenance detection signal 95 in 10 seconds or less (YES in step S212), the processing proceeds to step S213. In step S213, the charge removal CPU 82 determines that the dirtiness degree of the ionizer 52 is heavy. In step S216, the charge removal CPU 82 notifies the main body CPU 61 via the communication I/F 87 of the information indicating the determined dirtiness degree or the information indicating the cleaning method corresponding to the heavy level of the dirtiness degree. Then, the charge removal CPU 82 ends the processing. In addition, in the case where the charge removal CPU 82 determines that the dirtiness degree of the ionizer 52 is heavy, the charge removal CPU 82 notifies the main body CPU 61 of the information indicating a cleaning method using a grinding stone. In step S216, the charge removal CPU 82 notifies the main body CPU 61 of the maintenance warning via the communication I/F 87.

In a case where the ionizer 52 does not output the maintenance detection signal 95 in 10 seconds or less (NO in step S212), the processing proceeds to step S214. In step S214, the charge removal CPU 82 determines whether the ionizer 52 outputs the maintenance detection signal 95 in 30 seconds or less. In a case where the ionizer 52 outputs the maintenance detection signal 95 in 30 seconds or less (YES in step S214), the processing proceeds to step S215. In step S215, the charge removal CPU 82 determines that the dirtiness degree of the ionizer 52 is light. In step S216, the charge removal CPU 82 notifies the main body CPU 61 via the communication I/F 87 of the information indicating the determined dirtiness degree or the information indicating the cleaning method corresponding to the light level of the dirtiness degree. Then, the charge removal CPU 82 ends the processing. In addition, in the case where the charge removal CPU 82 determines that the dirtiness degree of the ionizer 52 is light, the charge removal CPU 82 notifies the main body CPU 61 of the information indicating a cleaning method using a cotton-tipped stick. In step S216, the charge removal CPU 82 notifies the main body CPU 61 via the communication I/F 87 of the maintenance warning. In addition, in the present exemplary embodiment, the 10 seconds after the maintenance detection start is a threshold value for determining the dirtiness degree of the ionizer 52.

In a case where the ionizer 52 does not output the maintenance detection signal 95 in 30 seconds or less (NO in step S214), the charge removal CPU 82 ends the processing. More specifically, the charge removal CPU 82 does not notify the main body CPU 61 of the information indicating the cleaning method. In other words, the charge removal CPU 82 does not provide the maintenance warning notification. Further, in a case where the driving time accumulated value is less than 600 seconds (NO in step S209), the charge removal CPU 82 ends the processing. At this time, since the cleaning of the ionizer 52 is not required, the charge removal CPU 82 displays the screen in FIG. 4A on the main body display unit 66.

In addition, the accumulation of the driving time of the ionizer 52 includes the driving time period for the previous job. For this reason, the driving time period for the previous job is stored in a non-volatile memory. However, the measurement of the deriving time period may be continued from the value at the previous job end time. In this case, step S208 is omitted, and the charge removal CPU 82 may determine whether the measurement value at the time point of step S207 is 600 seconds or more in step S209 described below.

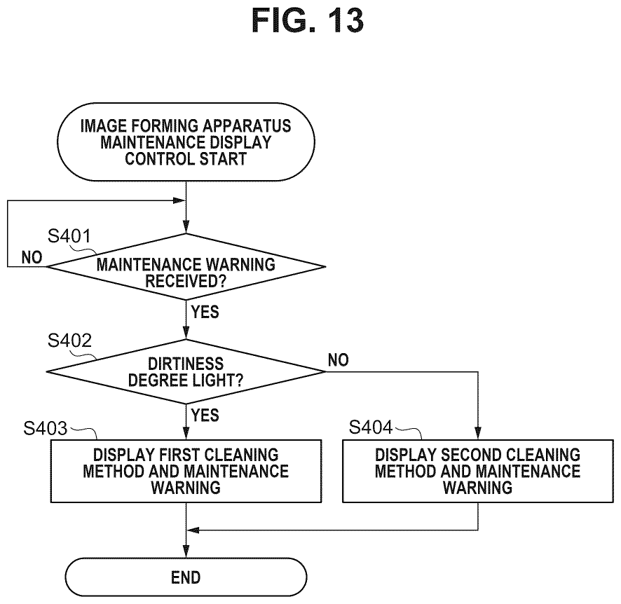

FIG. 13 is a flowchart illustrating a maintenance display control flow of the image forming apparatus 100 performed by the main body CPU 61. In step S401, the image forming apparatus 100 determines whether the maintenance warning is received from the charge removal apparatus 200 via the communication I/F 68. In a case where the image forming apparatus 100 determines that the maintenance warning is received (YES in step S401), the processing proceeds to step S402. In this case, the main body CPU 61 displays a cleaning method corresponding to the dirtiness degree of the ionizer 52 received from the charge removal apparatus 200 on the main body display unit 66.

In step S402, the main body CPU 61 determines whether the dirtiness degree of the ionizer 52 received from the charge removal CPU 82 is light. In a case where the main body CPU 61 determines that the dirtiness degree of the ionizer 52 is light (YES in step S402), the processing proceeds to step S403. In step S403, the main body CPU 61 displays on the main body display unit 66 a screen in FIG. 4B indicating that the maintenance using a cotton-tipped stick (first cleaning method) is required. Then, the main body CPU 61 ends the processing. In a case where the main body CPU 61 determines that the dirtiness degree of the ionizer 52 received from the charge removal CPU 82 is not light (NO in step S402), the processing proceeds to step S404. In step S404, the main body CPU 61 displays on the main body display unit 66 a screen in FIG. 4C indicating that a maintenance using a grinding stone (second cleaning method) is required. Then, the main body CPU 61 ends the processing. In addition, in steps S403 and S404, the main body CPU 61 displays on the main body display unit 66 a maintenance warning for recommending a cleaning. In addition, in the present exemplary embodiment, the case where the dirtiness degree of the ionizer 52 is not light (NO in step S402) corresponds to the case where the dirtiness degree of the ionizer 52 is heavy”. In the present exemplary embodiment, the main body CPU 61 has received the information about the dirtiness degree from the charge removal CPU 82, and the main body CPU 61 displays the cleaning method corresponding to the received dirtiness degree on the main body display unit 66. However, it is not limited thereto, and the main body CPU 61 may receive the information about the cleaning method corresponding to the determined dirtiness degree from the charge removal CPU 82.

As described above, in the present exemplary embodiment, in the case where the time period from starting the maintenance detection to receiving the maintenance detection signal 95 is a first time period, the cleaning method using the cotton-tipped stick (first member) is displayed on the main body display unit 66. Further, in the case where the time period from starting the maintenance detection to receiving the maintenance detection signal 95 is a second time period shorter than the first time period, the cleaning method using the grinding stone (second member) is displayed on the main body display unit 66.

In this way, it is possible to prevent the early deterioration of the electrode needle caused by the excessive maintenance or the charge removal ability deficiency caused by the insufficient maintenance, by displaying the appropriate maintenance method from the plurality of maintenance methods on the main body display unit 66.

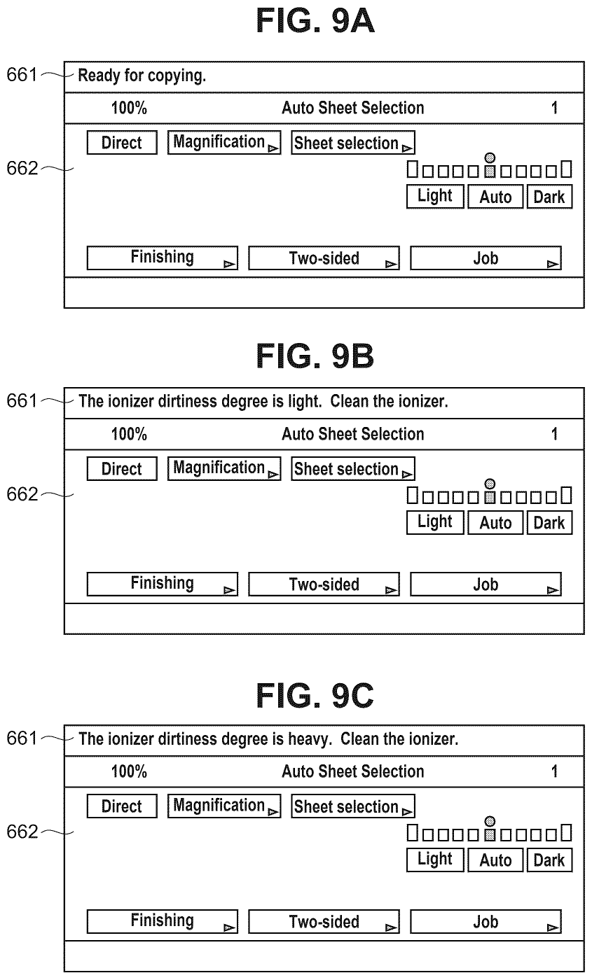

In the present exemplary embodiment, the maintenance method (cleaning method) is displayed on the main body display unit 66, but it is not limited thereto. As illustrated in FIGS. 9A, 9B, and 9C, the dirtiness degree of the ionizer 52 or the charge removal performance may be displayed on the main body display unit 66. FIG. 9A illustrates a screen of the main body display unit 66 displayed in the case where the maintenance detection signal 95 is not output, FIG. 9B illustrates a screen of the main body display unit 66 displayed in the case where the dirtiness degree is determined to be light, and FIG. 9C illustrates a screen of the main body display unit 66 displayed in the case where the dirtiness degree is determined to be heavy. More specifically, the screen in FIG. 9A does not display the dirtiness degree of the ionizer 52. The screen in FIG. 9B displays a message indicating that the dirtiness degree of the ionizer 52 is light, and a message for prompting a user to clean the ionizer 52. The screen in FIG. 9C displays a message indicating that the dirtiness degree of the ionizer 52 is heavy, and a message for prompting a user to clean the ionizer 52.

The dirtiness degree of the ionizer 52 or the charge removal performance may be displayed on the main body display unit 66 in step S403 or step S404 in the flowchart in FIG. 13. More specifically, in the case where the main body CPU 61 determines that the dirtiness degree of the ionizer 52 received from the charge removal CPU 82 is light (YES in step S402), the processing proceeds to step S403. In step S403, the main body CPU 61 displays the message indicating that the dirtiness degree of the ionizer 52 is light on the main body display unit 66 as illustrated in FIG. 9B. Then, the main body CPU 61 ends the processing. In the case where the main body CPU 61 determines that the dirtiness degree of the ionizer 52 received from the charge removal CPU 82 is not light (NO in step S402), the processing proceeds to step S404. In step S404, the main body CPU 61 displays the message indicating that the dirtiness degree of the ionizer 52 is heavy on the main body display unit 66 as illustrated in FIG. 9C. Then, the main body CPU 61 ends the processing. In addition, in the present exemplary embodiment, the case where the dirtiness degree of the ionizer 52 is not the light level (NO in step S402) corresponds to the case where the dirtiness degree of the ionizer 52 is heavy. However, as for the charge removal performance, the case where the dirtiness degree is heavy corresponds to the case where the charge removal performance is low, and the case where the dirtiness degree is light corresponds to a case where the charge removal performance is moderate, in the present exemplary embodiment. In addition, both the maintenance method and the dirtiness degree may be displayed.

It becomes possible for a user to easily determine the timing of the maintenance and to easily understand the degree of the cleaning, by displaying the dirtiness degree of the ionizer 52 or the charge removal performance. For example, when a user receives the notification indicating that the dirtiness degree of the ionizer 52 is light, but in a case where the user wants to prioritize the productivity, it is also possible for the user not to perform the maintenance of the ionizer 52 and input the next job. Since the user understands the dirtiness degree, the user can determine the maintenance timing in consideration of the productivity and the quality. However, in the case where the dirtiness degree of the ionizer 52 or the charge removal performance is displayed, one maintenance method may be displayed, because there is not necessarily a plurality of the maintenance methods.

In the present exemplary embodiment, the main body display unit 66 of the image forming apparatus 100 is used to display the maintenance method or the dirtiness degree of the ionizer 52 to the user. However, it is not limited thereto, and the maintenance method or the dirtiness degree of the ionizer 52 may be displayed on the charge removal display unit 56 of the charge removal apparatus 200. For example, the user may be notified of the dirtiness degree of the ionizer 52 or the charge removal performance, by changing the display color, the brightness, or the cycle of ON and OFF of a light-emitting diode (LED) of the charge removal display unit 56. Alternatively, for example, the user may be notified of the cleaning method using the display of the charge removal display unit 56.

In the present exemplary embodiment, the charge removal CPU 82 can execute a charge removal mode for removing charge of a sheet by the ionizer 52, and a maintenance necessity detection mode for detecting whether a maintenance is required for the ionizer 52. In the present exemplary embodiment, the charge removal mode and the maintenance necessity detection mode are not executed at a time, but it is not limited thereto, and the maintenance necessity may be detected while performing the charge removal of the sheet.

In addition, in the present exemplary embodiment, the charge removal CPU 82 determines the dirtiness degree of the ionizer 52, but is not limited thereto. The main body CPU 61 may determine the dirtiness degree of the ionizer 52. In the present exemplary embodiment, the charge removal CPU 82 and the main body CPU 61 are examples of a control unit (determination unit).

In the present exemplary embodiment, the needle-shaped electrode portion is used as the ionizer 52, but a corotron method using a wire as a line-shaped electrode portion may be employed. For the cleaning of the corona discharging wire, there is a method of cleaning the discharging wire by pressing a felt or the like, but the stress on the corona discharging wire becomes large, and the lifetime of the corona discharging wire may become shorter. For this reason, for example, in a case where the dirtiness degree of the discharging wire is determined to be light, a message for recommending a cleaning method using a brush may be displayed, and in a case where the dirtiness degree of the discharging wire is determined to be heavy, a message for recommending a cleaning method using a felt may be displayed.

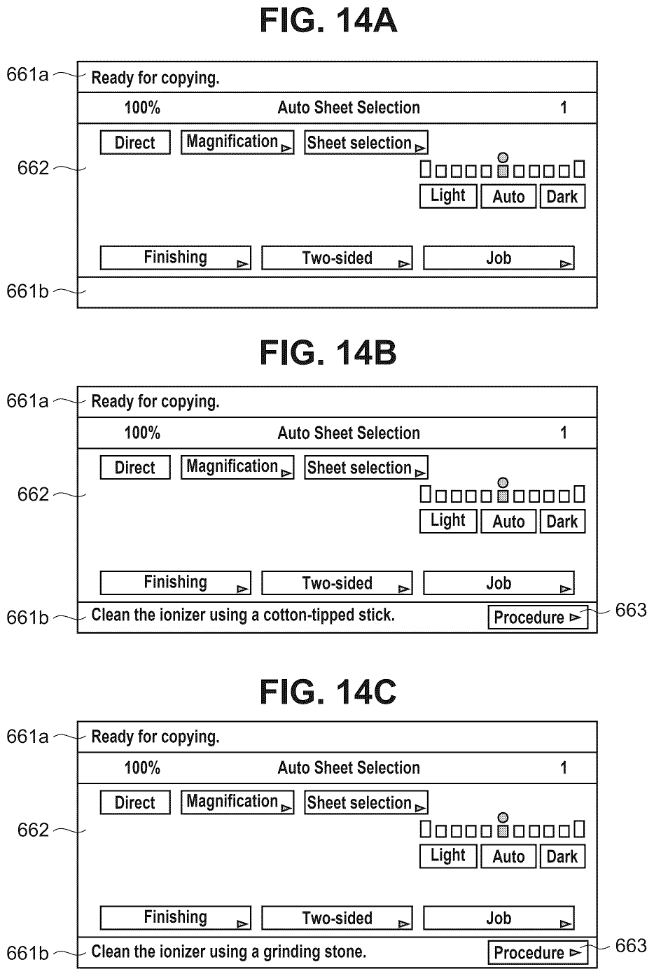

FIGS. 14A, 14B, and 14C illustrate modification examples of the screens displayed on the main body display unit 66. FIG. 14A illustrates a display screen of the main body display unit 66 displayed in a case where the maintenance detection signal 95 is not output. FIG. 14B illustrates a display screen of the main body display unit 66 displayed in a case where the dirtiness degree is determined to be light. FIG. 14C illustrates a display screen of the main body display unit 66 displayed in a case where the dirtiness degree is determined to be heavy.

Each of the display screens includes an upper side status area 661a arranged on an upper side of the display screen to display a status of the image forming apparatus 100, and a lower side status area 661b arranged on a lower side of the display screen to display a dirtiness degree of the ionizer 52 or a maintenance method. Further, each of the display screens includes the job setting area 662 between the upper side status area 661a and the lower side status area 661b. The job setting area 662 is used to set job contents.

As illustrated in FIG. 14A, in the case where the maintenance detection signal 95 is not output, a message indicating that “Ready for copying (copy is possible)” is displayed in the upper side status area 661a. In the present exemplary embodiment, even in a case where the notification of the maintenance warning of the ionizer 52 is provided, the main body CPU 61 can accept a job. For this reason, both in the case where the dirtiness degree is determined to be light as in FIG. 14B and in the case where the dirtiness degree is determined to be heavy as in FIG. 14C, the message indicating that “Ready for copying”is displayed in the upper side status area 661a.

The screen in FIG. 14B displays a message for prompting a user to clean the ionizer 52 using a cotton-tipped stick in the lower side status area 661b. The screen in FIG. 14C displays a message for prompting a user to clean the ionizer 52 using a grinding stone in the lower side status area 661b. Further, in a case where the cleaning method or the maintenance warning is to be displayed, a guidance key 663 for displaying a guidance of a cleaning procedure is displayed in the lower side status area 661b. In a case where the user presses the guidance key 663, the guidance of the cleaning procedure is displayed on the display screen. More specifically, as the cleaning procedure, a method of accessing the electrode portion of the ionizer 52 by the user, or a cleaning method using the cleaning member may be explained using illustrations, messages, moving images, or the like. For example, as the method of accessing the electrode portion of the ionizer 52, “lifting the upper side unit 401 of the charge removal apparatus 200” may be displayed.

In the first exemplary embodiment, the dirtiness degree of the ionizer 52 is determined based on the timing at which the maintenance detection signal 95 indicating that the maintenance is required is received. In a second exemplary embodiment, the dirtiness degree of the ionizer 52 is determined based on environment information. Since a basic configuration of the second exemplary embodiment is similar to that of the first exemplary embodiment, only the difference will be described.

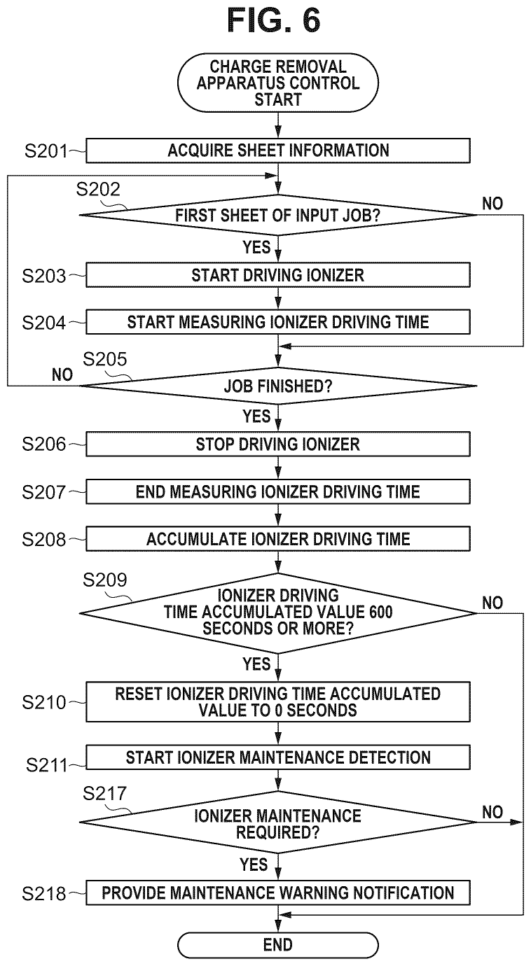

FIG. 6 illustrates a charge removal apparatus control flow performed by the charge removal CPU 82. Since processing in steps S201 to S211 in FIG. 6 is the same as the processing in steps S201 to S211 in FIG. 5, the description thereof is omitted in part. In step S209, the charge removal CPU 82 determines whether the driving time accumulated value is 600 seconds or more. In a case where the driving time accumulated value is 600 seconds or more (YES in step S209), the processing proceeds to step S210. In step S210, the charge removal CPU 82 resets the driving time accumulated value of the ionizer 52 to 0. In step S211, the charge removal CPU 82 switches the maintenance detection mode shift signal 93 from the L level to the H level to cause the ionizer 52 to start the maintenance detection.

In step S217, the charge removal CPU 82 determines whether the maintenance of the ionizer 52 is required. In a case where the ionizer 52 outputs the maintenance detection signal 95, the charge removal CPU 82 determines that the maintenance of the ionizer 52 is required (YES in step S217), and the processing proceeds to step S218. In step S218, the charge removal CPU 82 notifies the image forming apparatus 100 of a maintenance warning via the communication I/F 87. Then, the charge removal CPU 82 ends the processing. Further, in a case where the driving time accumulated value of the ionizer 52 is less than 600 seconds (NO in step S209) or the maintenance of the ionizer 52 is determined not to be required (NO in step S217), the charge removal CPU 82 ends the processing.

The dirtiness degree of the ionizer 52 varies depending on an environment (temperature, humidity, and water content). In particular, in the environment including a large water content, the ionizer 52 is more likely to get dirty. For this reason, in a case where it is determined that a maintenance is required, the dirtiness degree of the ionizer 52 varies depending on the difference of the environment. Thus, in the second exemplary embodiment, in a case where it is determined that a maintenance is required, the dirtiness degree is determined based on the environment information, and a user is notified of a dirtiness degree or a maintenance method.

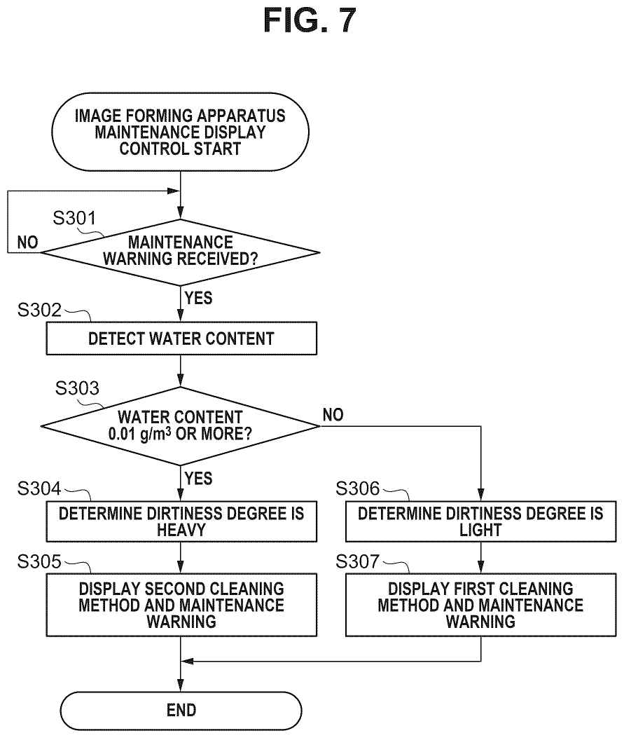

FIG. 7 is a flowchart illustrating a maintenance display control flow of the image forming apparatus 100 performed by the main body CPU 61. With reference to a screen display of a user operation unit illustrated in each of FIGS. 4A, 4B, and 4C, the maintenance display control flow will be described. In step S301, the image forming apparatus 100 determines whether a maintenance warning is received from the charge removal apparatus 200 via the communication I/F 68. In a case where the image forming apparatus 100 determines that the maintenance warning is received (YES in step S301), the processing proceeds to step S302. In step S302, the main body CPU 61 performs water content detection in the air. The water content is calculated from the detection results of the temperature sensor 77 and the humidity sensor 78. In step S303, the main body CPU 61 determines whether the water content in the air is 0.01 g/m³ or more. In a case where the water content in the air is 0.01 g/m³ or more (YES in step S303), the processing proceeds to step S304. In step S304, the main body CPU 61 determines that the dirtiness degree of the ionizer 52 is heavy. In step S305, the main body CPU 61 displays a message indicating that a maintenance using a grinding stone (second cleaning method) is required on the main body display unit 66 as illustrated in FIG. 4C. Then, the main body CPU 61 ends the processing. On the other hand, in a case where the water content in the air is less than 0.01 g/m³ (NO in step S303), the processing proceeds to step S306. In step S306, the main body CPU 61 determines that the dirtiness degree of the ionizer 52 is light. In step S307, the main body CPU 61 displays a message indicating that a maintenance using a cotton-tipped stick (first cleaning method) is required on the main body display unit 66 as illustrated in FIG. 4B. Then, the main body CPU 61 ends the processing. In addition, in steps S305 and S307, the main body CPU 61 displays on the main body display unit 66 a maintenance warning for recommending a cleaning.

As described above, in the present exemplary embodiment, in a case where the detected water content is less than a predetermined amount, the main body CPU 61 determines that the dirtiness degree of the ionizer 52 is light, and in a case where the detected water content is a predetermined amount or more, the main body CPU 61 determines that the dirtiness degree of the ionizer 52 is heavy. In other words, in a case where the water content is a first amount, the main body CPU 61 displays on the main body display unit 66 the cleaning method using the cotton-tipped stick serving as a first member, and in a case where the water content is a second amount larger than the first amount, the main body CPU 61 displays on the main body display unit 66 the cleaning method using the grinding stone (second member) harder than the first member.

In the present exemplary embodiment, the main body CPU 61 executes the water content detection after receiving the maintenance waring notification from the charge removal apparatus 200, but it is not limited thereto. The water content detection may be executed at predetermined intervals, regardless of the maintenance warning notification. More specifically, the main body CPU 61 may determine the dirtiness degree of the ionizer 52 based on the water content detected last when the main body CPU 61 receives the maintenance warning notification from the charge removal apparatus 200, from among the water content detections executed at the predetermined intervals.

In the present exemplary embodiment, the dirtiness degree is determined based on the water content, but it is not limited thereto, and may be determined based on, for example, humidity. In the present exemplary embodiment, the temperature sensor 77 and the humidity sensor 78 are disposed in the image forming apparatus 100, but may be disposed in the charge removal apparatus 200.

However, since the image forming apparatus 100 is typically provided with a temperature sensor and a humidity sensor to detect an indoor environment in which the image forming apparatus 100 is installed, using the sensors removes the necessity of providing new sensors, which can reduce the cost.

Further, also in the present exemplary embodiment, the user is notified of the maintenance method of the ionizer 52, but the user may be notified of the dirtiness degree of the ionizer 52 or the charge removal performance. In a case where the dirtiness degree of the ionizer 52 or the charge removal performance is displayed on the main body display unit 66, the dirtiness degree corresponding to the determination result may be displayed in step S305 or in step S307. Further, in the present exemplary embodiment, the maintenance method of the ionizer 52 is displayed on the main body display unit 66, but may be displayed on the charge removal display unit 56.

In the present exemplary embodiment, the ionizer control unit 521 performs the maintenance detection control, but it is not limited thereto, and the charge removal CPU 82 may perform the maintenance detection control. Further, in the present exemplary embodiment, the main body CPU 61 determines the dirtiness degree of the ionizer 52, but it is not limited thereto. The charge removal CPU 82 may determine the dirtiness degree of the ionizer 52.

With the control described above, it is possible to prevent the early deterioration of the electrode needle due to the excessive maintenance, and the charge removal ability deficiency caused by the insufficient maintenance, by displaying the dirtiness degree of the ionizer 52 or the appropriate maintenance method on the main body display unit 66.

According to the present disclosure, a user can perform an appropriate maintenance method for a non-contact charge removal unit.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-129221, which was filed on Aug. 5, 2024, and Japanese Patent Application No. 2024-129222, which was filed on Aug. 5, 2024, both of which are hereby incorporated by reference herein in their entireties.

What is claimed is:

1. A charge removal apparatus comprising:
a non-contact charge removal unit including an electrode portion for generating ions and configured to remove charge of a sheet using the ions generated by the electrode portion in a non-contact state with the sheet on which an image is formed by an image forming unit; and
a display unit configured to selectively display a cleaning method of the electrode portion from among a plurality of cleaning methods.

2. The charge removal apparatus according to claim 1, further comprising a processor configured to determine the cleaning method to be displayed on the display unit,
wherein the non-contact charge removal unit is configured to execute a maintenance detection for detecting whether a cleaning of the electrode portion is required, and
wherein the processor determines the cleaning method of the electrode portion based on a time period from a start of the maintenance detection until a reception of a signal output in a case where the cleaning of the electrode portion is required.

3. The charge removal apparatus according to claim 2,
wherein the processor determines the cleaning method using a first member in a case where the time period until the reception of the signal is a first time period, and
wherein the processor determines the cleaning method using a second member harder than the first member in a case where the time period until the reception of the signal is a second time period shorter than the first time period.

4. The charge removal apparatus according to claim 2, wherein the maintenance detection is performed by measuring an ion amount generated from the electrode portion and by measuring a balance of positive ions and negative ions generated from the electrode portion.

5. The charge removal apparatus according to claim 1, further comprising a processor configured to determine the cleaning method to be displayed on the display unit,
wherein the image forming unit includes a sensor configured to obtain environment information, and
wherein the processor determines the cleaning method of the electrode portion based on the environment information obtained by the sensor.

6. The charge removal apparatus according to claim 5, wherein the sensor includes a temperature sensor and a humidity sensor.

7. The charge removal apparatus according to claim 5,
wherein the environment information is a water content,
wherein the processor determines the cleaning method using a first member in a case where the water content is a first amount, and
wherein the processor determines the cleaning method using a second member harder than the first member in a case where the water content is a second amount larger than the first amount.

8. The charge removal apparatus according to claim 1, further comprising a processor configured to determine the cleaning method to be displayed on the display unit,
wherein the processor determines a dirtiness degree of the electrode portion, and
wherein the display unit displays the dirtiness degree of the non-contact charge removal unit based on a determination result of the processor.

9. The charge removal apparatus according to claim 1, further comprising a contact charge removal unit configured to remove the charge of the sheet in a contact state with the sheet,
wherein the non-contact charge removal unit is disposed on a downstream side of the contact charge removal unit in a sheet conveyance direction.

10. The charge removal apparatus according to claim 1, wherein the display unit displays a procedure of the cleaning method.

11. The charge removal apparatus according to claim 1,
wherein the non-contact charge removal unit is configured to execute a maintenance detection of detecting whether a cleaning of the electrode portion is required, and
wherein in a case where an execution result of the maintenance detection is that the cleaning of the electrode portion is required, the display unit selectively displays a cleaning method from a first cleaning method using a first cleaning member and a second cleaning method using a second cleaning member.

12. An image processing system comprising:
the charge removal apparatus according to claim 1; and
the image forming unit,
wherein the image forming unit includes a transfer portion configured to transfer a toner image formed on a transfer belt onto the sheet.

13. An image processing system comprising:
an image forming unit configured to form an image on a sheet;
a non-contact charge removal unit including an electrode portion for generating ions and configured to remove charge of the sheet using the ions generated by the electrode portion in a non-contact state with the sheet on which the image is formed by the image forming unit; and
a display unit configured to selectively display a cleaning method of the electrode portion from among a plurality of cleaning methods.

14. A display method performed in an image forming system including an image forming unit configured to form an image on a sheet, a non-contact charge removal unit including an electrode portion and configured to remove charge of the sheet on which the image is formed by the image forming unit in a non-contact state, and a display unit configured to display information, the display method comprising:
acquiring a user selection of a cleaning method suitable to clean an electrode portion of a current state from among a plurality of cleaning methods, in a case where a cleaning of the electrode portion is required; and
displaying the selected cleaning method on the display unit.
